(19) United States
(12) Patent Application Publication
(10) Pub. No.: US 2017/0057586 A1
(43) Pub. Date: Mar. 2, 2017

(54) STRADDLED VEHICLE

(71) Applicant: YAMAHA HATSUDOKI KABUSHIKI KAISHA, Iwata-shi (JP)

(72) Inventor: Takeshi IGARASHI, Shizuoka (JP)

(21) Appl. No.: 15/230,506

(22) Filed: Aug. 8, 2016

(30) Foreign Application Priority Data
Sep. 1, 2015 (JP) 2015-172077

(51) Int. Cl. B62K 11/12; B60K 1/02; B62L 5/00; B62K 11/04

(52) U.S. Cl. CPC B62K 11/12; B62K 11/04; B60K 1/02; B62L 5/006

(57) ABSTRACT

A straddled vehicle includes a battery, a front wheel mounted on an axle, a motor including a stator and a rotor rotatable around the axle together with the front wheel, the motor being supplied with electric power from the battery to generate motive power, and a front suspension supporting, in a cantilever manner, the axle being inserted through the front wheel and the motor.

### BACKGROUND OF THE INVENTION

1. Field of the Invention

The present invention relates to a straddled vehicle, and specifically to a straddled vehicle including a motor that drives a front wheel.

2. Description of the Related Art

Recently, it has been proposed to use an electric motor as a driving source of a motorcycle. In general, a rear wheel is driven by an internal combustion engine. Use of a motor instead of an engine allows a rear wheel to be electrically driven. Use of a motor that drives a front wheel (hereinafter, referred to as a “front motor”) in addition to an engine or a motor that drives the rear wheel achieves a dual drive (all-wheel drive).

Japanese Laid-Open Patent Publication No. 2010-228570 discloses a motorcycle including an engine that drives a rear wheel and a motor that drives a front wheel (front motor). In the motorcycle disclosed in Japanese Laid-Open Patent Publication No. 2010-228570, the front motor is located in a wheel hub of the front wheel.

In a motorcycle, the work of attaching or detaching a wheel is preferably as simple as possible in order to replace the tires or the like. In the case where the front motor is located in the vicinity of the front wheel, as in the motorcycle disclosed in Japanese Laid-Open Patent Publication No. 2010-228570, the ease of attaching or detaching the front wheel is decreased as described below.

In the motorcycle disclosed in Japanese Laid-Open Patent Publication No. 2010-228570, the front wheel and the motor are tightened together and thus secured between the left and right front forks by an axle and an axle nut. Therefore, the front wheel may be detached by detaching the axle nut that secures the axle. In Japanese Laid-Open Patent Publication No. 2010-228570, the front motor is located in the wheel hub of the front wheel. Therefore, in order to allow only the front wheel to be detached, a space is needed in which the front wheel is movable without disturbing the front motor. However, the left and right front forks are located on both sides of the front wheel. As a result, the above-described space is not provided, which makes it difficult to detach only the front wheel. In Japanese Laid-Open Patent Publication No. 2010-228570, the front motor needs to be detached together with the front wheel. In this case, a harness such as an electric power cable or the like needs to be pulled out and cut, which complicates the work of detaching the front wheel.

### SUMMARY OF THE INVENTION

Preferred embodiments of the present invention provide a straddled vehicle, including a front motor, that improves the ease of attaching or detaching the front wheel.

A straddled vehicle according to a preferred embodiment of the present invention includes a battery; a front wheel mounted on an axle; a motor including a stator and a rotor rotatable around the axle together with the front wheel, the motor being supplied with electric power from the battery to generate motive power; and a front suspension supporting, in a cantilever manner, the axle inserted through the front wheel and the motor.

In a preferred embodiment of the present invention, as seen in a front view of the vehicle, the axle includes a first portion located in a first direction parallel or substantially parallel to the axle with respect to a vehicle center line and a second portion located in a second direction opposite to the first direction with respect to the vehicle center line; and the first portion of the axle is supported by the front suspension and the second portion of the axle is not supported by the front suspension.

In a preferred embodiment of the present invention, as seen in a front view of the vehicle, the motor is supported by the front suspension on a side of the axle, with respect to the vehicle center line, which is supported by the front suspension.

In a preferred embodiment of the present invention, the motor is located between the front wheel and the front suspension.

In a preferred embodiment of the present invention, a plurality of elements located in the vicinity of the axle are tightened together by a tightening member.

In a preferred embodiment of the present invention, the motor is secured to the front suspension and is not attached to the front wheel.

In a preferred embodiment of the present invention, the straddled vehicle further includes a linkage that defines and functions as a detent for the front suspension.

In a preferred embodiment of the present invention, the straddled vehicle further includes a steering device. The front suspension includes a suspension top portion attached to the steering device and a suspension bottom portion attached so as to be movable in a stroke direction with respect to the suspension top portion; and the linkage is attached to bridge the suspension top portion and the suspension bottom portion.

In a preferred embodiment of the present invention, the straddled vehicle further includes a brake caliper supported by the axle.

In a preferred embodiment of the present invention, the straddled vehicle further includes a bracket located between the brake caliper and the axle. The brake caliper is supported by the axle via the bracket; and the bracket includes a detent mechanism for the axle.

In a preferred embodiment of the present invention, the brake caliper is located on the same side as the front wheel with respect to the front suspension.

In a preferred embodiment of the present invention, as seen in a front view of the vehicle, the brake caliper is located outward of the front wheel in a vehicle width direction.

In a preferred embodiment of the present invention, as seen in a front view of the vehicle, the front suspension is located on one side with respect to the vehicle center line, and the brake caliper is located on the other side with respect to the vehicle center line.

In a preferred embodiment of the present invention, the straddled vehicle further includes a brake disc attached to the front wheel.

In a preferred embodiment of the present invention, the straddled vehicle further includes a pair of bearings rotatably supporting the axle. As seen in a front view of the vehicle, one of the pair of bearings is located on one side with respect to the vehicle center line, and the other bearing is located on the other side with respect to the vehicle center line.

In a preferred embodiment of the present invention, the straddled vehicle further includes a steering shaft; and a steering corrector that provides the steering shaft with an urging force cancelling a moment around a steering axial line, the moment acting on the steering shaft.

In a preferred embodiment of the present invention, the steering corrector is located on the opposite side to the motor with respect to the steering shaft.

According to another preferred embodiment of the present invention, a straddled vehicle includes a steering shaft; a front wheel steerable by rotation of the steering shaft; an axle inserted through the front wheel; a front suspension that supports the axle in a cantilever manner; and a steering corrector that provides the steering shaft with an urging force canceling a moment around a steering axial line, the moment acting on the steering shaft.

A straddled vehicle according to a preferred embodiment of the present invention preferably includes the front suspension supporting, in a cantilever manner, the axle inserted through the front wheel and the motor (namely, the front suspension of a cantilever type). Therefore, the ease of attaching or detaching the front wheel is improved.

The axle inserted through the front wheel preferably includes a first portion located in a first direction parallel or substantially parallel to the axle with respect to a vehicle center line and a second portion located in a second direction opposite to the first direction with respect to the vehicle center line, as seen in a front view of the vehicle; and the first portion of the axle is supported by the front suspension and the second portion of the axle is not supported by the front suspension.

From the point of view of further improving the ease of attaching or detaching the front wheel, it is preferable that the motor is supported by the front suspension on the side, with respect to the vehicle center line, on which the axle is supported by the front suspension, as seen in a front view of the vehicle. Namely, it is preferable that the motor is located between the front wheel and the front suspension.

A structure in which the plurality of elements located in the vicinity of the axle are tightened together by a tightening member decreases the number of elements.

With a structure in which the motor is secured to the front suspension and is not attached to the front wheel, the motor does not need to be detached in order to detach the front wheel. Therefore, the ease of attaching or detaching the front wheel is further improved.

A straddled vehicle according to a preferred embodiment of the present invention preferably includes a linkage that defines a detent for the front suspension. The linkage prevents a portion of the front suspension from rotating with respect to another portion of the front suspension.

The front suspension preferably includes a suspension top portion attached to the steering device and a suspension bottom portion attached so as to be movable in a stroke direction with respect to the suspension top portion. In this case, the linkage is attached to and bridges the suspension top portion and the suspension bottom portion.

A straddled vehicle according to a preferred embodiment of the present invention preferably further includes a brake caliper supported by the axle.

The brake caliper may be supported by the axle via the bracket located between the brake caliper and the axle. With this structure, the brake caliper includes a detent structure for the axle. Thus, the rotation torque at the time of deceleration is properly received.

The brake caliper is preferably located on the same side as the front wheel with respect to the front suspension.

From the point of view of weight balance and the degree of freedom of layout of a driving mechanism such as the motor or the like, it is preferable that the brake caliper is located outward of the front wheel in the vehicle width direction as seen in a front view of the vehicle. In other words, it is preferable that, as seen in a front view of the vehicle, the front suspension is located on one side with respect to the vehicle center line, whereas the brake caliper is located on the other side with respect to the vehicle center line.

A straddled vehicle according to a preferred embodiment of the present invention preferably further includes a brake disc attached to the front wheel.

In the case where the straddled vehicle further includes a pair of bearings rotatably supporting the axle, it is preferable that one of the pair of bearings is located on one side with respect to the vehicle center line, whereas the other bearing is located on the other side with respect to the vehicle center line, as seen in a front view of the vehicle. This structure allows the load from the tire to be divided, and therefore, the bearings are decreased in size and have an extended life.

A straddled vehicle according to a preferred embodiment of the present invention preferably further includes a steering corrector that provides the steering shaft with an urging force cancelling a moment around a steering axial line, the moment acting on the steering shaft. The steering corrector significantly reduces or prevents the decrease in the steerability caused by the generation of a steering force not intended by the rider.

In the case where the urging force provided by the steering corrector is a pulling force, the steering corrector is located on the opposite side to the motor with respect to the steering shaft. In the case where the urging force provided by the steering corrector is a pushing force, the steering corrector is located on the same side as the motor with respect to the steering shaft.

According to still another preferred embodiment of the present invention, a straddled vehicle includes a front suspension supporting, in a cantilever manner, the axle inserted through the front wheel. Therefore, the ease of attaching or detaching the front wheel is improved. According to still another preferred embodiment of the present invention, a straddled vehicle includes a steering corrector providing the steering shaft with an urging force cancelling a moment around a steering axial line, the moment acting on the steering shaft. Therefore, the decrease in the steerability caused by the generation of a steering force not intended by the rider is significantly reduced or prevented.

According to the various preferred embodiments of the present invention, straddled vehicles, including a front motor, improve the ease of attaching or detaching the front wheel.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a left side view schematically showing a straddled vehicle (motorcycle) 1 according to a preferred embodiment of the present invention.

FIG. 2 is an exploded isometric view schematically showing a front wheel 2 and the vicinity thereof of the motorcycle 1.

FIG. 3 is a cross-sectional view schematically showing the front wheel 2 and the vicinity thereof.

FIG. 4 is a right side view of the front wheel 2 and the vicinity thereof.

FIG. 5 is a left side view of a restrictor 61 of the motorcycle 1.

FIG. 6 is a front view of the restrictor 61.

FIG. 7 is a bottom view of elements in the vicinity of a steering axial line sa of the motorcycle 1.

FIG. 8 is an isometric view schematically showing elements in the vicinity of the steering axial line sa.

FIG. 9 is a side view schematically showing the motorcycle 1 in an example in which the motorcycle 1 includes a steering corrector 90.

FIG. 10 is an isometric view schematically showing the motorcycle 1 in the example in which the motorcycle 1 includes the steering corrector 90.

FIG. 11 is a cross-sectional view schematically showing the steering corrector 90.

FIG. 12 is a graph showing an example of relationship of the steering angle (deg) with the unbalance moment Mt1 (Nm) and the correction moment Mt2 (Nm).

### DETAILED DESCRIPTION OF THE PREFERRED EMBODIMENTS

Hereinafter, preferred embodiments of the present invention will be described with reference to the attached drawings. The present invention is not limited to the following preferred embodiments.

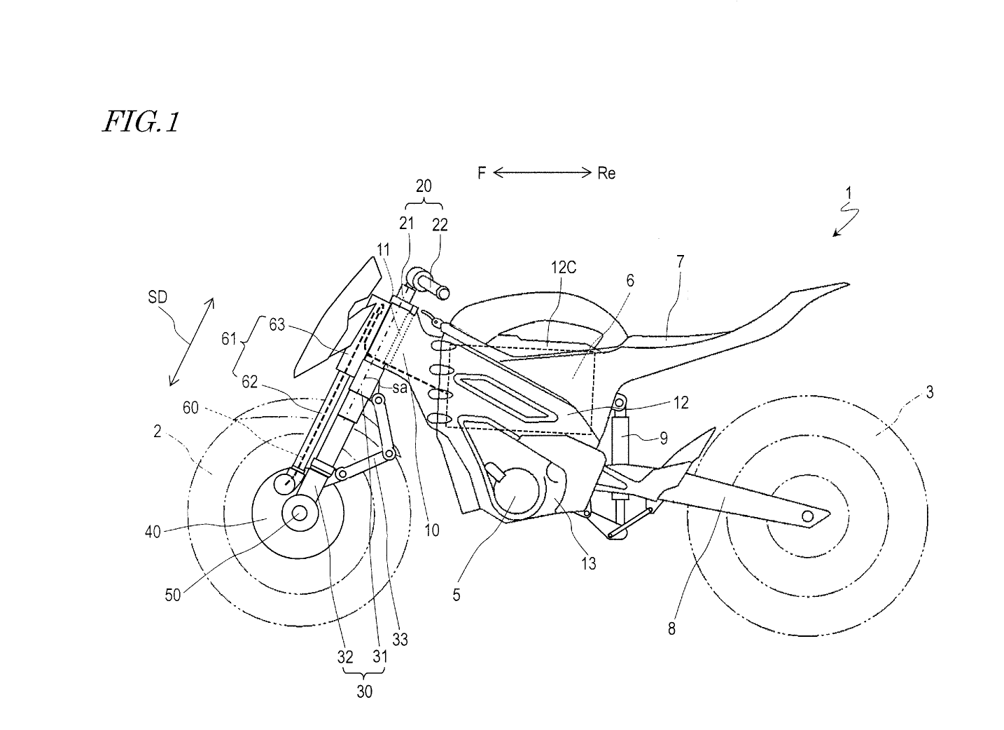

FIG. 1 shows a straddled vehicle 1 according to a preferred embodiment of the present invention. As shown in FIG. 1, the straddled vehicle 1 is an on-road type motorcycle, for example. The motorcycle according to the preferred embodiments of the present invention is not limited to an on-road type motorcycle. The motorcycle may be of any type including, for example, a so-called off-road type, a moped type, a scooter type or the like. The “straddled vehicle” according to various preferred embodiments of the present invention refers to a vehicle which a rider rides astride, and is not limited to a two-wheeled vehicle. The straddled motorcycle according to a preferred embodiment of the present invention may be, for example, a leaning multi-wheel (LMW), which changes the advancing direction by inclining the vehicle body, or may be any other type of straddled vehicle such as an ATV (All Terrain Vehicle) or the like.

In this specification, the terms “front”, “rear”, “left” and “right” respectively refer to front, rear, left and right as seen from a rider of the motorcycle 1. In the figures, F, Re, L and R respectively represent front, rear, left and right.

As shown in FIG. 1, the motorcycle 1 includes a vehicle body frame 10, a steering device 20, a front suspension 30, a front wheel 2 and a rear wheel 3. The motorcycle 1 also includes a motor 40 that generates motive power used to drive the front wheel 2 (hereinafter, such a motor will be referred to as a “front motor 40”), a motor 5 that generates motive power used to drive the rear wheel 3 (hereinafter, such a motor will be referred to as a “rear motor 5”), and a battery 6 that supplies electric power to the front motor 40 and the rear motor 5.

The vehicle frame 10 includes a head pipe 11 located at a frontmost position of the vehicle frame 10, a battery case 12 and a motor case 13. The battery case 12 and the motor case 13 are located to the rear of the head pipe 11. The vehicle frame 10 supports a seat 7 on which a driver is to sit.

The battery case 12 in the vehicle frame 10 accommodates the battery 6. More specifically, the battery 6 is attached to the vehicle frame 10. The battery case 12 is preferably box-shaped and includes an opening at a top surface thereof. The top surface of the battery case 12 is covered with a case cover 12C.

The battery 6 is, for example, a lithium-ion battery. The battery 6 may be detachable from the vehicle frame 10. The battery 6 is not limited to a single battery, and a plurality of (i.e., two or more) batteries 6 may be accommodated in the battery case 12. The battery 6 supplies electric power to both a cable for a low voltage system and a cable for a high voltage system. The cable for the low voltage system supplies electric power to assisting elements such as a lamp, an ECU and the like, and in general, supplies a voltage of about 12 V, for example. The cable for the high voltage system supplies electric power to the front motor 40 and the rear motor 5 (namely, supplies electric power used to generate the driving power), and supplies a voltage higher than the voltage to be supplied by the cable for the low voltage system. The cable for the high voltage system is different from the cable for the low voltage system.

The battery 6 does not need to be directly attached to the vehicle frame 10. In this specification, the expression that “the battery 6 is attached to the vehicle frame 10” encompasses a case where the battery 6 is directly attached to the vehicle frame 10 and a case where the battery 6 is attached to the vehicle frame 10 indirectly (namely, including a component other than the vehicle frame 10 between the battery 6 and the vehicle frame 10).

The motor case 13 accommodates a rear wheel driving system including the rear motor 5. The rear wheel 3 to be driven by the rear motor 5 is attached to a rear arm 8. Motive power generated by the rear motor 5 is transmitted to the rear wheel 3 via a belt or a chain (not shown). A rear suspension 9 is located to the rear of the battery case 12 and the motor case 13. A top end of the rear suspension 9 is attached to a rear wall of the battery case 12. A bottom end of the rear suspension 9 is supported by the motor case 13 via, for example, a linkage.

The steering device 20 includes a steering shaft 21 inserted through the head pipe 11 and a handle 22 attached to a top end of the steering shaft 21. The steering device 20 is pivotable around a steering axial line sa (central axis of the steering shaft 21) with respect to the vehicle frame 10. The pivoting of the steering device 20 (rotation of the steering shaft 21) steers the front wheel 2.

The front suspension 30 is coupled with the steering device 20. The front suspension 30 includes a portion attached to the steering device 20 (hereinafter, such a portion will be referred to as a “suspension top portion 31”) and a portion attached so as to be movable in a stroke direction SD with respect to the suspension top portion 31 (hereinafter, such a portion will be referred to as a “suspension bottom portion 32”).

In the case where the front suspension 30 is of a telescopic type, one of the suspension top portion 31 and the suspension bottom portion 32 includes an outer tube, and the other of the suspension top portion 31 and the suspension bottom portion 32 includes an inner tube. In the motorcycle 1 shown in FIG. 1, the front suspension 30 is of an upside-down type. The suspension top portion 31 includes an outer tube, and the suspension bottom portion 32 includes an inner tube. By contrast, in the case where the front suspension 30 is of a normal type, the suspension top portion 31 includes an inner tube, and the suspension bottom portion 32 includes an outer tube.

A linkage 33 is attached to bridge the suspension top portion 31 and the suspension bottom portion 32. The linkage 33 acts as a detent for the front suspension 30.

An axle 50 is inserted through the front wheel 2. The front wheel 2 is attached to the front suspension 30 so as to be rotatable around the axle 50.

The front motor 40 is located in the vicinity of the front wheel 2. The front motor 40 is supplied with electric power from the battery 6 to generate motive power. As the front motor 40, a DC brushless motor, for example, is preferably used.

In this preferred embodiment, the front suspension 30 preferably is located only on one side in a vehicle width direction (in the example shown in FIG. 1, the left side of the vehicle). Namely, there is only one front fork, which is located on the left side of the vehicle, and no front fork is located on the right side of the vehicle. The front suspension 30 supports, in a cantilever manner, the axle 50 inserted through the front wheel 2 and the front motor 40.

The front motor 40 and the battery 6 are electrically connected with each other by an electric power cable 60. The electric power cable 60 is a cable for the high voltage system (high voltage cable). The electric power cable 60, as a high voltage cable, preferably has a diameter of, for example, about 5 mm (20 mm²) or greater.

The motorcycle 1 in this preferred embodiment also includes a restrictor 61 that restricts movement of the electric power cable 60 to the stroke direction SD of the front suspension 30. The restrictor 61 includes a guide 62 and an accommodation portion 63 as described below in detail.

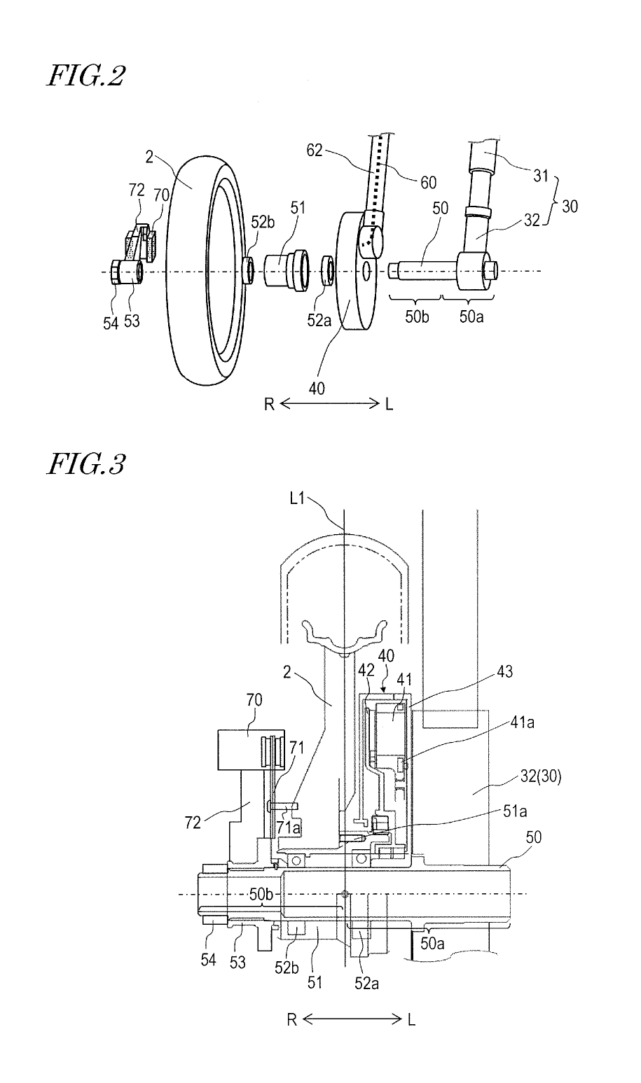

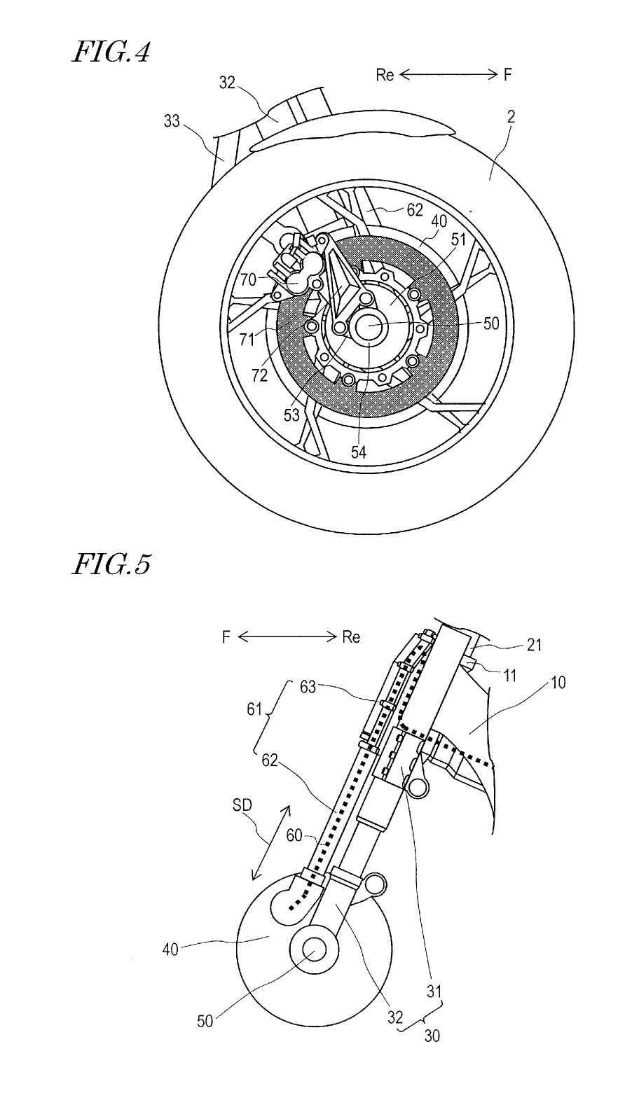

Hereinafter, a specific structure of the front suspension 30 of a cantilever type and the restrictor 61 will be described. First, with reference to FIG. 2, FIG. 3 and FIG. 4, a specific structure of the front suspension 30 of the cantilever type will be described. FIG. 2 is an exploded isometric view of the front wheel 2 and the vicinity thereof, and FIG. 3 is a cross-sectional view of the front wheel 2 and the vicinity thereof. FIG. 4 is a right side view of the front wheel 2 and the vicinity thereof.

As described above, the front suspension 30 supports the axle 50 in a cantilever manner. As shown in FIG. 2 and FIG. 3, as seen in a front view of the vehicle, the axle 50 includes a first portion 50a located in a first direction parallel or substantially parallel to the axle 50 with respect to a vehicle center line L1 and a second portion 50b located in a second direction opposite to the first direction with respect to the vehicle center line L1 (see FIG. 3) (in this example, the first direction is a leftward direction L, and the second direction is a rightward direction R). The first portion 50a of the axle 50 is supported by the front suspension 30, whereas the second portion 50b of the axle 50 is not supported by the front suspension 30.

The axle 50 is inserted through a center hub 51 located at a center of the front wheel 2 and through the front motor 40. The center hub 51 is cylindrical and is secured to the front wheel 2 by a bolt 51a, for example. The axle 50 is rotatably supported in the center hub 51 by a pair of bearings (in this example, ball bearings) 52a and 52b. As seen in a front view of the vehicle, one of the pair of bearings 52a and 52b, specifically, the bearing 52a is located on one side (in this example, the left side of the vehicle) with respect to the vehicle center line L1, and the other bearing 52b is located on the other side (in this example, the right side of the vehicle) with respect to the vehicle center line L1. The center hub 51 does not need to be separate from the front wheel 2, and may be integral with the front wheel 2.

The front motor 40 includes a stator 41, a rotor 42, and a housing 43 accommodating the stator 41 and the rotator 42. The stator 41 is secured to the housing 43 by a bolt 41a, for example. The rotor 42 is rotatable around the axle 50 together with the front wheel 2. The rotor 42 is coupled with the center hub 51 via a one-way clutch or a decelerator.

The front motor 40 is located between the front wheel 2 and the front suspension 30. Namely, as seen in a front view of the vehicle, the front motor 40 is supported by the front suspension 30 on the side, with respect to the vehicle center line L1, on which the axle 50 is supported by the front suspension 30 (namely, supported on the side of the first portion 50a).

The front motor 40 is secured to the front suspension 30 and is not attached to the front wheel 2. Specifically, the housing 43 of the front motor 40 and the suspension bottom portion 32 are secured to each other by a key structure, and this arrangement causes the front motor 40 to be secured to the front suspension 30. Needless to say, the structure of securing the front motor 40 to the front suspension 30 is not limited to the above-described structure, and the front motor 40 may be secured to the front suspension 30 with a bolt or any of various other structures.

As shown in FIG. 2, FIG. 3 and FIG. 4, the motorcycle 1 further includes a brake caliper 70 supported by the axle 50 and a brake disc 71 attached to the front wheel 2. The brake disc 71 is tightened to the front wheel 2 by a bolt 71a, for example.

The brake caliper 70 is supported by the axle 50 via a bracket 72 located between the brake caliper 70 and the axle 50. The bracket 72 is attached to a brake hub 53 located on the opposite side to the front motor 40 and the front suspension 30 with respect to the center hub 51. The brake hub 53 is cylindrical, and the axle 50 is inserted through the brake hub 53. The brake hub 53 is coupled with the axle 50 by serrated engagement. Therefore, the bracket 72 attached to the brake hub 53 provides a detent mechanism for the axle 50.

The brake caliper 70 is located on the same side as the front wheel 2 with respect to the front suspension 30. As seen in a front view of the vehicle, the brake caliper 70 is located outward of the front wheel 2 in the vehicle width direction. In other words, as seen in a front view of the vehicle, the front suspension 30 is located on one side with respect to the vehicle center line L1 (in this example, on the left side of the vehicle), whereas the brake caliper 70 is located on the other side (in this example, on the right side of the vehicle) with respect to the vehicle center line L1.

The plurality of elements located in the vicinity of the axle 50 (the front motor 40, the bearings 52a and 52b, etc.) are tightened together by a tightening member (e.g., a shaft end nut) 54.

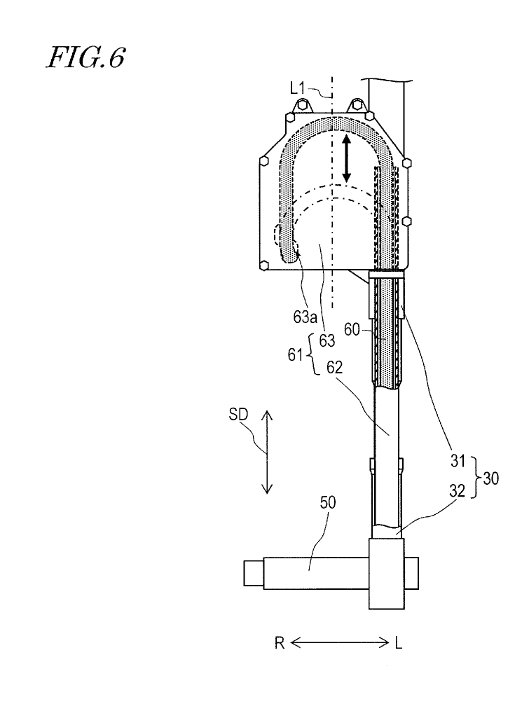

Now, with reference to FIG. 5 and FIG. 6, a specific structure of the restrictor 61 will be described. FIG. 5 is a left side view of the restrictor 61, and FIG. 6 is a front view of the restrictor 61. In FIG. 5 and FIG. 6, a number of the elements of the motorcycle 1 may be omitted or cut out.

As shown in FIG. 5 and FIG. 6, the restrictor 61 includes the guide 62 and the accommodation portion 63.

The guide 62 is preferably pipe-shaped, and extends parallel or substantially parallel to the stroke direction SD. A portion of the electric power cable 60 is inserted through the guide 62. The guide 62 is preferably made of a metal material such as an aluminum alloy or the like.

The guide 62 is secured to the suspension bottom portion 32 directly or indirectly. In this preferred embodiment, a bottom end of the guide 62 is attached to the front motor 40, and the guide 62 is secured to the suspension bottom portion 32 via the front motor 40. The electric power cable 60 is secured to the guide 62 at an appropriate position in the guide 62 (at one position or a plurality of positions). Therefore, the guide 62 and the electric power cable 60 move integrally in the stroke direction SD in accordance with the movement of the suspension bottom portion 32 with respect to the suspension top portion 31.

The accommodation portion 63 is provided on the suspension top portion 31. In the accommodation portion 63, a portion of the electric power cable 60 is accommodated in a sagging state. The accommodation portion 63 is preferably box-shaped, and is preferably made of a metal material (e.g., aluminum alloy). A specific shape of the accommodation portion 63 is not limited to the shape shown in FIG. 6 and the like.

A portion (top end) of the guide 62 is inserted into the accommodation portion 63 from a bottom left of the accommodation portion 63, and slides in the accommodation portion 63 along with the stroke of the front suspension 30. The amount of stroke of the front suspension 30 is, for example, about 100 mm to about 150 mm. One end of the electric power cable 60 is connected with the front motor 40, and the electric power cable 60 extends from the front motor 40 toward the vehicle frame 10 via the guide 62, the accommodation portion 63 and an opening 63a at a bottom right of the accommodation portion 63. As the guide 62 slides during the stroke of the front suspension 30, a portion of the electric power cable 60 that is inside the accommodation portion 63 and is exposed from the guide 62 also moves in the stroke direction SD (see FIG. 6).

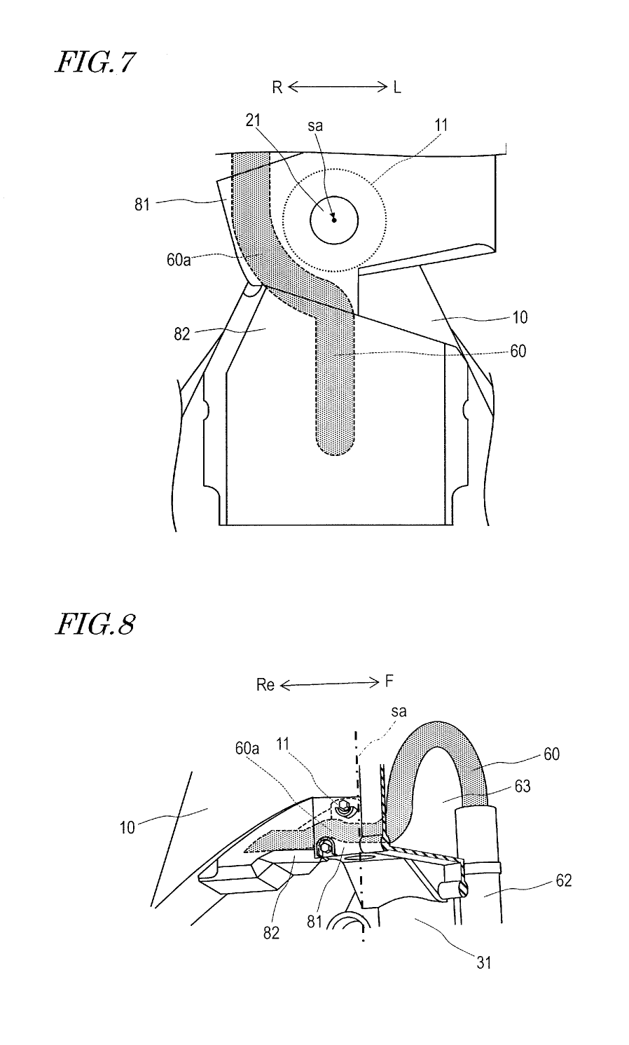

As shown in FIG. 6, as seen from a front of the vehicle, the electric power cable 60 extends over the vehicle center line L1. As shown in FIG. 1, the electric power cable 60 passes the vicinity of the steering axial line sa and connects the battery 6 and the front motor 40 with each other. FIG. 7 is a bottom view of elements in the vicinity of the steering axial line sa. FIG. 8 is an isometric view of elements in the vicinity of the steering axial line sa.

As shown in FIG. 7 and FIG. 8, the electric power cable 60 includes a portion 60a bypassing the head pipe 11 (hereinafter, such a portion will be referred to as a “bypass portion 60a”). Covers 81 and 82 are provided so as to cover the bypass portion 60a. The covers 81 and 82 are preferably made of a metal material (e.g., aluminum alloy). In this example, the bypass portion 60a is covered with the two covers 81 and 82. One of the covers 81 and 82, more specifically, the cover 81 is attached to the suspension top portion 31, whereas the other cover 82 is attached to the suspension bottom portion 32. The number and the shape(s) of the covers covering the bypass portion 60a are not limited to those shown. The electric power cable 60 may be inserted through the head pipe 11 and the steering shaft 21.

As described above, the motorcycle 1 in this preferred embodiment includes the front suspension 30 supporting, in a cantilever manner, the axle 50 inserted through the front wheel 2 and the front motor 40. Namely, the front suspension 30 is of a cantilever type. Therefore, the ease of attaching or detaching the front wheel 2 is improved as compared with in the case where a conventional front suspension supporting the axle with two forks on both of the left side and the right side is used.

From the point of view of further improving the ease of attaching or detaching the front wheel 2, it is preferable that, as shown in FIG. 3 and the like, the front motor 40 is supported by the front suspension 30 on the side, with respect to the vehicle center line L1, on which the axle 50 is supported by the front suspension 30, as seen in a front view of the vehicle. Namely, it is preferable that the front motor 40 is located between the front wheel 2 and the front suspension 30.

In this preferred embodiment, the plurality of elements located in the vicinity of the axle 50 are tightened together by the tightening member 54. Such a structure decreases the number of elements.

In this preferred embodiment, the front motor 40 is secured to the front suspension 30 and is not attached to the front wheel 2. Such a structure does not require the front motor 40 to be detached in order to detach the front wheel 2. Therefore, the ease of attaching or detaching the front wheel 2 is further improved.

As shown in FIG. 1 and the like, the motorcycle 1 preferably further includes the linkage 33 that acts as a detent for the front suspension 30. The linkage 33 prevents the suspension bottom portion 32 from rotating with respect to the suspension top portion 31.

In this preferred embodiment, the bracket 72 includes a detent structure for the axle 50. Therefore, in the case where the brake caliper 70 is supported by the axle 50 via the bracket 72 (see, for example, FIG. 3), the rotation torque at the time of deceleration is properly received.

From the point of view of weight balance and the degree of freedom of layout of a driving mechanism such as the front motor 40 or the like, it is preferable that the brake caliper 70 is located outward of the front wheel 2 in the vehicle width direction as seen in a front view of the vehicle. In other words, it is preferable that as seen in a front view of the vehicle, the front suspension 30 is located on one side with respect to the vehicle center line L1, whereas the brake caliper 70 is located on the other side with respect to the vehicle center line L1.

It is preferable that, as seen in a front view of the vehicle, one of the pair of bearings 52a and 52b, more specifically, the bearing 52a is located on one side with respect to the vehicle center line L1, whereas the other bearing 52b is located on the other wide with respect to the vehicle center line L1. This structure allows the load from the tire to be divided, and therefore, the bearings 52a and 52b have a decreased size and an extended life.

The motorcycle 1 in this preferred embodiment includes the restrictor 61 that restricts movement of the electric power cable 60 to the stroke direction SD of the front suspension 30. Therefore, sagging of the electric power cable 60 caused by the movement of the front motor 40 with respect to the battery 6 is absorbed by the movement of the electric power cable 60 in the stroke direction SD. This allows the electric power cable 60 to not protrude from the front suspension 30.

The restriction of the movement of the electric power cable 60 by the restrictor 61 is preferably achieved by an arrangement in which the restrictor 61 includes the pipe-shaped guide 62 extending parallel or substantially parallel to the stroke direction SD. A portion of the electric power cable 60 is inserted through the guide 62, and as a result, movement of the electric power cable 60 is restricted to the stroke direction SD in the guide 62.

The restrictor 61 preferably includes the accommodation portion 63 provided on the suspension top portion 31 and accommodating a portion of the electric power cable 60 in a sagging state. The accommodation portion 63 as described above absorbs the sagging of the electric power cable 60.

As shown in FIG. 7 and FIG. 8, the covers 81 and 82 cover the portion 60a, of the electric power cable 60, bypassing the head pipe 11 (bypass portion 60a). The covers 81 and 82 prevent the electric power cable 60 from being damaged.

As shown in FIG. 6, as seen in a front view of the vehicle, the electric power line 60 extends over the vehicle center line L1. Such an arrangement further reduces or prevents the electric power line 60 from protruding in the vehicle width direction.

Now, an example of a preferred structure of the motorcycle 1 will be described. In the case where the driving mechanism such as the front motor 40 or the like is located in the vicinity of the front wheel 2, there may be a case where the weight of the steering system (more specifically, the weight of the steering device 20 and the elements hanging therefrom) may be different between the left side and the right side of the vehicle. In such a case, a steering force is generated on the heavier side. As a result, the steerability may be decreased; for example, the straightness of the advancing direction may be decreased, or the turning performance may be different between left turns and right turns. This problem tends to be caused in the case where the front suspension 30 of the cantilever type is used. The reason is as follows. In the case where the front suspension 30 of the cantilever type is used, the fork is located only on one side; and therefore, if the driving mechanism is located on the same side as the fork, the weight difference between the left side and the right side tends to be further increased.

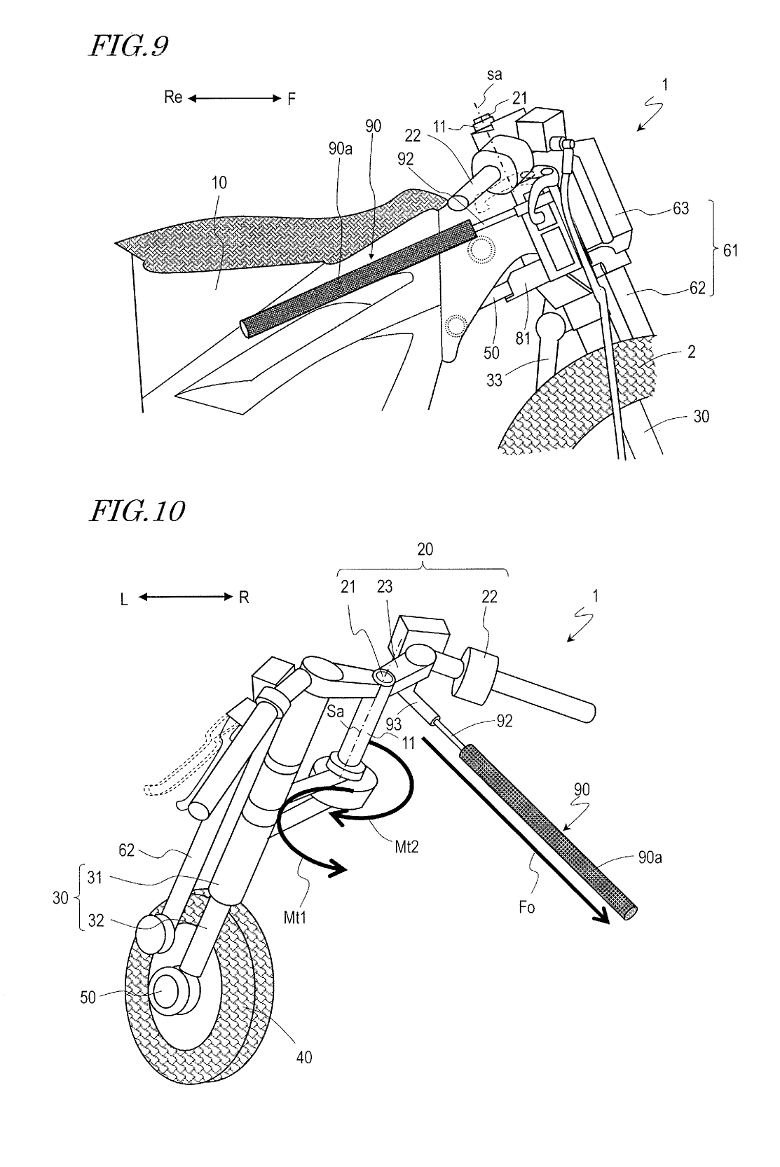

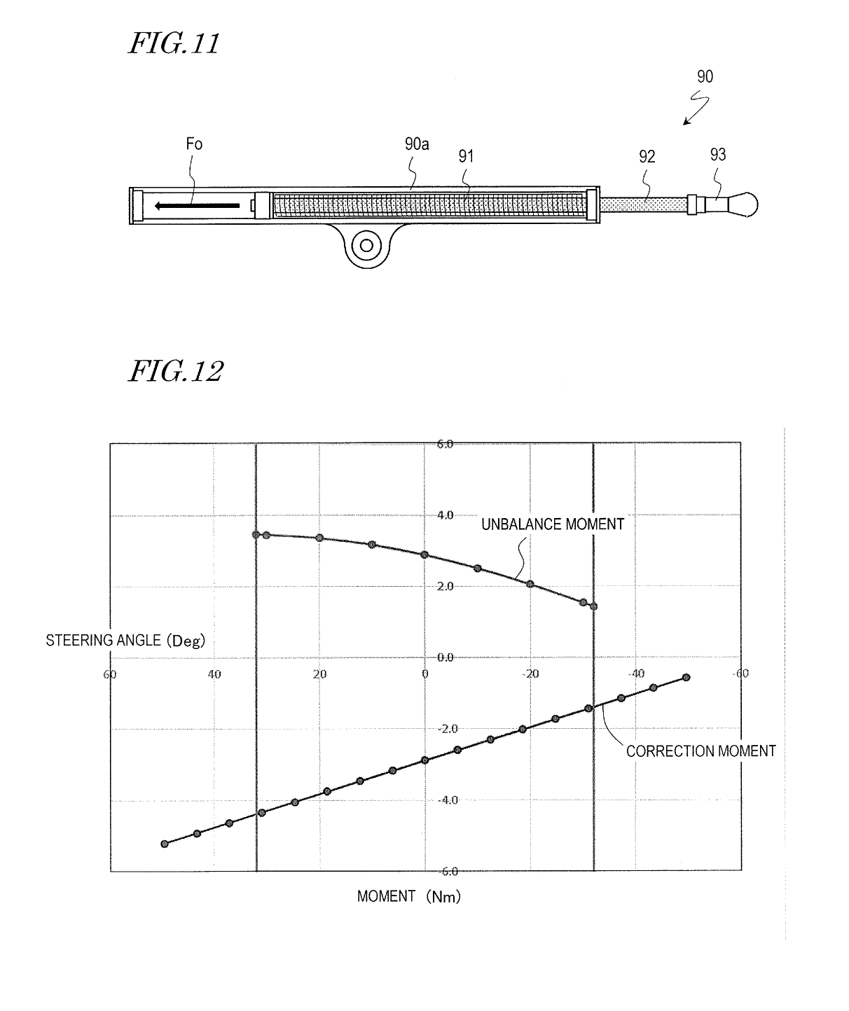

The above-described problem (decrease in the steerability) may be prevented by providing a steering corrector 90 as shown in FIG. 9, FIG. 10 and FIG. 11. FIG. 9 and FIG. 10 are respectively a side view and an isometric view schematically showing the motorcycle 1 in an example in which the motorcycle 1 includes the steering corrector 90. FIG. 11 is a cross-sectional view schematically showing the steering corrector 90.

As described above, when there is weight unbalance (weight difference between the left side and the right side), a moment Mt1 around the steering axial line sa (hereinafter, referred to as “unbalance moment Mt1”) acts on the steering shaft 21. The unbalance moment Mt1 (in this example, counterclockwise moment) may generate a steering force not intended by the rider.

The steering corrector 90 provides the steering shaft 21 with an urging force Fo cancelling the unbalance moment Mt1. Because of the urging force Fo, a moment opposite to the unbalance moment Mt1 (in this example, the moment opposite to the unbalance moment Mt1 is a clockwise moment Mt2, and hereinafter, will be referred to as a “correction moment Mt2”) acts on the steering shaft 21. In this manner, the steering corrector 90 significantly reduces or prevents the decrease in the steerability caused by the generation of a steering force not intended by the rider.

The steering corrector 90 in this example is preferably a spring damper including a compression spring 91 shown in FIG. 11. The spring damper 90 includes a damper main body 90a preferably having a cylindrical shape with a bottom, a damper rod 92 inserted into the damper main body 90a, and a coupling member 93 connected to a tip of the damper rod 92. The compression spring 91 is inserted around the damper rod 92. The damper main body 90a is secured to the vehicle frame 10. The coupling member 93 is coupled with the steering device 20 (more specifically, to a bracket 23 of the steering device 20).

As can be seen from FIG. 9 and FIG. 10, the spring damper 90 is located on the opposite side to the front motor 40 with respect to the steering shaft 21. In the spring damper 90, a pulling force (pulling load) is generated as the urging force Fo by the compression spring 91.

FIG. 12 shows an example of relationship of the steering angle (deg) with the unbalance moment Mt1 (Nm) and the correction moment Mt2 (Nm). As shown in FIG. 12, the urging force Fo of the spring damper 90 is set so as to generate the correction moment Mt2 cancelling the unbalance moment Mt1, and thus the steerability is significantly reduced or prevented from being decreased. From the point of view of sufficiently reducing or prevented the decrease in steerability, it is preferable that the difference between the absolute value of the unbalance moment Mt1 and the absolute value of the correction moment Mt2 is as small as possible in a desired steering angle range. However, the correction moment Mt2 does not need to totally cancel the unbalance moment Mt1. It is sufficient that the difference between the absolute value of the unbalance moment Mt1 and the absolute value of the correction moment Mt2 is within a predetermined range.

The spring damper 90 may include a spring other than the compression spring 91 instead of the compression spring 91 (for example, may include a torsion spring). The steering corrector 90 does not need to be a spring damper. The steering corrector 90 may be a hydraulic damper, an electric actuator or the like.

In the above-described example, the spring damper 90 generates a pulling force (pulling load) as the urging force Fo. The steering corrector 90 may generate a pushing force (pushing load) as the urging force Fo. In the case of generating a pushing force, the steering corrector 90 is located on the same side as the front motor 40 with respect to the steering shaft 21.

In the above-described preferred embodiments, the motorcycle 1 includes the rear motor 5. Preferred embodiments of the present invention may be applied to a motorcycle including an internal combustion engine (engine) generating motive power used to drive the rear wheel, instead of the rear motor 5.

The steering corrector 90 described above with reference to FIG. 9 and the like may be used for a motorcycle (straddled vehicle) that does not include the front motor 40. Even in a motorcycle not including the front motor 40, a weight unbalance may occur in the case where the front suspension 30 of the cantilever type is used. The provision of the steering corrector 90 significantly reduces or prevents the decrease in the steerability caused by the generation of a steering force not intended by the rider.

In the preferred embodiments of the present invention, the straddled vehicle including the front motor improves the ease of attaching or detaching the front wheel. The preferred embodiments of the present invention are preferably applicable to various types of straddled vehicles including a motorcycle.

While the present invention has been described with respect to preferred embodiments thereof, it will be apparent to those skilled in the art that the disclosed invention may be modified in numerous ways and may assume many preferred embodiments other than those specifically described above. Accordingly, it is intended by the appended claims to cover all modifications of the invention that fall within the true spirit and scope of the invention.

This application claims priority to Japanese Patent Application No. 2015-172077 filed on Sep. 1, 2015, the entire contents of which are hereby incorporated by reference.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A straddled vehicle comprising:
a battery;
a front wheel mounted on an axle;
a motor including a stator and a rotor rotatable around the axle together with the front wheel, the motor being supplied with electric power from the battery to generate motive power; and
a front suspension supporting, in a cantilever manner, the axle inserted through the front wheel and the motor.

2. The straddled vehicle according to claim 1, wherein
as seen in a front view of the vehicle, the axle includes a first portion located in a first direction parallel or substantially parallel to the axle with respect to a vehicle center line and a second portion located in a second direction opposite to the first direction with respect to the vehicle center line; and
the first portion of the axle is supported by the front suspension and the second portion of the axle is not supported by the front suspension.

3. The straddled vehicle according to claim 1, wherein, as seen in a front view of the vehicle, the motor is supported by the front suspension on a side of the axle, with respect to the vehicle center line, that is supported by the front suspension.

4. The straddled vehicle according to claim 1, wherein the motor is located between the front wheel and the front suspension.

5. The straddled vehicle according to claim 1, wherein a plurality of elements located in a vicinity of the axle are tightened together by a tightening member.

6. The straddled vehicle according to claim 1, wherein the motor is attached to the front suspension and is not attached to the front wheel.

7. The straddled vehicle according to claim 1, further comprising a linkage that defines and functions as a detent for the front suspension.

8. The straddled vehicle according to claim 7, further comprising a steering device; wherein
the front suspension includes a suspension top portion attached to the steering device and a suspension bottom portion attached so as to be movable in a stroke direction with respect to the suspension top portion; and
the linkage is attached to the suspension top portion and the suspension bottom portion.

9. The straddled vehicle according to claim 1, further comprising a brake caliper supported by the axle.

10. The straddled vehicle according to claim 9, further comprising a bracket located between the brake caliper and the axle; wherein
the brake caliper is supported by the axle via the bracket; and
the bracket includes a detent mechanism for the axle.

11. The straddled vehicle according to claim 9, wherein the brake caliper and the front suspension are located on a same side of the front wheel.

12. The straddled vehicle according to claim 11, wherein, as seen in a front view of the vehicle, the brake caliper is located outward of the front wheel in a vehicle width direction.

13. The straddled vehicle according to claim 9, wherein, as seen in a front view of the vehicle, the front suspension is located on a first side with respect to the vehicle center line, and the brake caliper is located on a second side, opposite to the first side, with respect to the vehicle center line.

14. The straddled vehicle according to claim 9, further comprising a brake disc attached to the front wheel.

15. The straddled vehicle according to claim 1, further comprising a pair of bearings rotatably supporting the axle; wherein
as seen in a front view of the vehicle, a first one of the pair of bearings is located on a first side with respect to the vehicle center line, and a second one of the pair of bearings is located on a second side, opposite to the first side, with respect to the vehicle center line.

16. The straddled vehicle according to claim 1, further comprising:
a steering shaft; and
a steering corrector that provides the steering shaft with an urging force cancelling a moment around a steering axial line, wherein the moment acts on the steering shaft.

17. The straddled vehicle according to claim 16, wherein the steering corrector is located on an opposite side of the steering shaft from the motor.
